(19) United States
(12) Patent Application Publication
(10) Pub. No.: US 2024/0424911 A1
(43) Pub. Date: Dec. 26, 2024

(54) DIRECT-AXIS VOLTAGE BASED ANGULAR OFFSET CALIBRATION IN AN ELECTRIC MOTOR

(71) Applicant: ATIEVA, INC., Newark, CA (US)

(72) Inventor: Hung-Yen Ou Yang, Newark, CA (US)

(21) Appl. No.: 18/704,003

(22) PCT Filed: Oct. 26, 2022
(86) PCT No.: PCT/US2022/078682

§ 371 Date: Apr. 23, 2024

Related U.S. Application Data
(60) Provisional application No. 63/263,265, filed on Oct. 29, 2021.

(51) Int. Cl. B60L 15/02; H02P 21/10; H02P 21/18

(52) U.S. Cl. CPC B60L 15/025; H02P 21/10; H02P 21/18; B60L 2240/421; B60L 2240/423; B60L 2240/427

(57) ABSTRACT

In a general aspect, a method includes measuring, for a permanent magnet motor having a rotor rotating at a speed, a direct-axis voltage in a rotor frame of reference. The speed is determined by an angular position sensor. The method further includes comparing the measured direct-axis voltage with a reference voltage, and determining, based on the comparing, an angle offset estimate of the angular position sensor. The method also includes iteratively adjusting the angle offset estimate until the measured direct-axis voltage substantially equals the reference voltage.

### CROSS-REFERENCE TO RELATED APPLICATION

This application claims the priority benefit of U.S. Provisional Application No. 63/263,265, entitled “DIRECT-AXIS VOLTAGE BASED ANGULAR OFFSET CALIBRATION IN AN ELECTRIC MOTOR”, filed Oct. 29, 2021, the disclosure of which is hereby incorporated by reference in its entirety.

### TECHNICAL FIELD

This document relates to calibration of angular offset in an electric motor, such as in a permanent magnet synchronous motor.

### BACKGROUND

In recent years, electric vehicle (EV) technology has continued to develop, and an increasing number of people are choosing to have an EV as a personal vehicle. Motors used in EVs (e.g., permanent magnet motors) can include, or be implemented with an angular position sensor that can provide angular position information for a rotor of the motor. That angular position information can be used for determining motor speed, controlling torque generation by the motor, etc. Offset (angle offset) between an angular position of a magnetic axis of a permanent magnet included in the rotor and the corresponding angular position information provided by the angular position sensor can adversely impact operation of the motor, such as by reducing torque generation efficiency.

### SUMMARY

In a general aspect, a method includes measuring, for a permanent magnet motor having a rotor rotating at a speed, a direct-axis voltage in a rotor frame of reference. The speed is determined by an angular position sensor. The method further includes comparing the measured direct-axis voltage with a reference voltage, and determining, based on the comparing, an angle offset estimate of the angular position sensor. The method also includes iteratively adjusting the angle offset estimate until the measured direct-axis voltage substantially equals the reference voltage.

Implementations can include one or more of the following features, or any combination thereof. For example, comparing the measured direct-axis voltage with the reference voltage can include comparing the measured direct-axis voltage with a reference voltage with a proportional integral controller. The reference voltage can be zero volts.

The proportional integral controller can be configured to implement a regulator controller. The proportional integral controller can be enabled in response to an enable signal and the speed being greater than or equal to a threshold speed.

The method can include generating torque with the permanent magnet motor based, at least in part, on the iteratively determined angle offset.

Measuring the direct-axis voltage can include measuring the direst-axis voltage with the rotor freely spinning at the speed.

In another general aspect, a vehicle includes a permanent magnet motor having a stator, a rotor, and an angular position sensor. The vehicle also includes a motor controller configured to measure, with the rotor rotating at a speed, a direct-axis voltage in a rotor frame of reference. The speed is determined by the angular position sensor. The motor controller is further configured to compare the measured direct-axis voltage with a reference voltage and determine, based on the comparing, an angle offset estimate of the angular position sensor. The motor controller is also configured to iteratively adjust the angle offset estimate until the measured direct-axis voltage substantially equals the reference voltage.

Implementations can include one or more of the following features, or any combination thereof. For example, the direct-axis voltage can be measured in the stator.

Comparing the measured direct-axis voltage with the reference voltage can include comparing the measured direct-axis voltage with a reference voltage with a proportional integral controller. The reference voltage can be zero volts.

The proportional integral controller can be configured to implement a regulator controller.

The proportional integral controller can be configured to be enabled in response to an enable signal, and the speed being greater than or equal to a threshold speed.

The permanent magnet motor can be configured to generate torque based, at least in part, on the iteratively determined angle offset.

Measuring the direct-axis voltage can include measuring the direct-axis voltage with the rotor freely spinning at the speed.

### BRIEF DESCRIPTION OF DRAWINGS

FIG. 1 shows an example of an electric vehicle.

FIG. 2 shows an example of a permanent magnet motor that can be included in the vehicle of FIG. 1.

FIG. 3 shows an example process for angular position sensor angle offset calibration that can be performed by the motor controller of the vehicle of FIG. 1.

FIG. 4 shows a more detailed implementation of the process of FIG. 3.

Like reference symbols in the various drawings indicate like elements.

### DETAILED DESCRIPTION

This document describes examples of systems and techniques to calibrate, or compensate for, an angle offset of a rotational position sensor included in, or used in conjunction with a permanent magnet synchronous motor (PMSM), such as in an electric vehicle (EV). Such angle offsets can be due to mechanical variations and/or tolerances that affect the angular orientation of a rotational sensor and corresponding PMSM. The approaches described herein can be used to calibrate control of a PMSM to compensate for an offset between a physical angle of a rotor in a PMSM (relative to a zero degree reference of the PMSM) and a measured angle of the rotor (relative to the zero degree reference) provided by a corresponding rotational position sensor. In example implementations, a motor control unit can use such angle offset calibration information when controlling the PMSM, which can improve torque generation efficiency of the PMSM, increase overall efficiency of a corresponding EV, and provide better control stability of the PMSM by its corresponding motor control unit.

Examples described herein refer to a vehicle. A vehicle is a machine that transports passengers or cargo, or both. A vehicle can have one or more motors using at least one type of fuel or other energy source (e.g., electricity). Examples of vehicles include, but are not limited to, cars, trucks, and buses. The number of wheels can differ between types of vehicles, and one or more (e.g., all) of the wheels can be used for propulsion of the vehicle. The vehicle can include a passenger compartment accommodating one or more persons. An EV can be powered exclusively by electricity, or can use one or more other energy sources in addition to electricity, such as petroleum, diesel fuel, or natural gas, to name just a few examples. As used herein, an EV includes an onboard energy storage, sometimes referred to as a battery pack, to power one or more electric motors. Two or more EVs can have different types of energy storages and/or different sizes thereof.

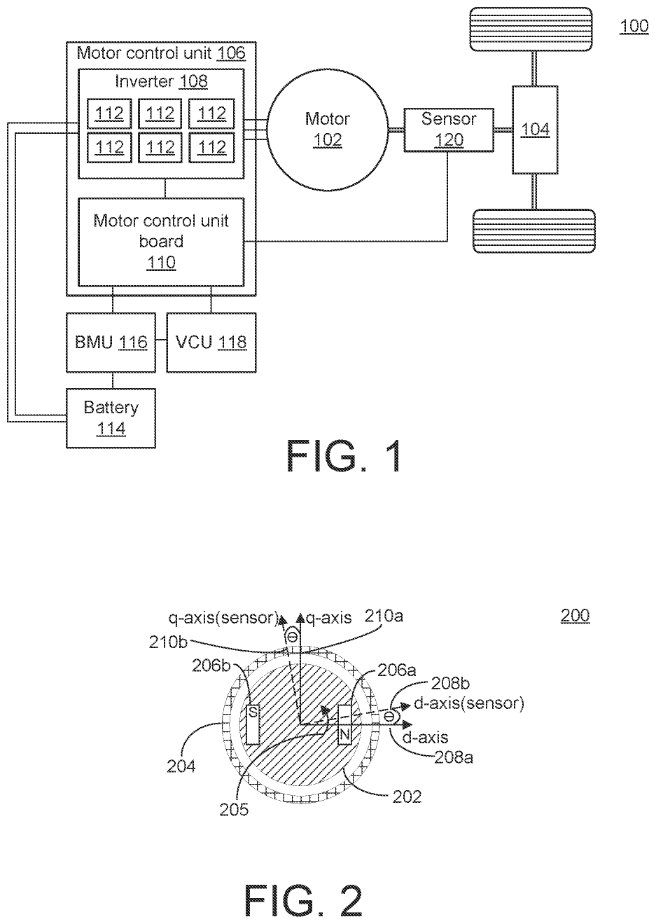

FIG. 1 shows an example of a vehicle 100 having a permanent magnet motor (motor) 102, which can be a PMSM. In this example, the motor 102 and/or other components of the vehicle 100 can be used with one or more other examples described elsewhere herein. Only portions of the vehicle 100 are shown, for simplicity. The motor 102 has one or more magnets positioned within, or on a surface of a rotor. The motor 102 can apply current to a stator surrounding the rotor to generate torque for one or more drive wheels. In some implementations, gears 104 can be provided between the motor 102 and the drive wheel(s). For example, the gears 104 can include a differential and/or can provide gear reduction.

The vehicle 100 can use a motor controller to operate the motor 102 as well as other components. Here, the vehicle 100 includes a motor control unit (MCU) 106 that includes an inverter 108 and an MCU board 110. The MCU board 110 controls the inverter 108. The MCU board 110 can include one or more processing components. In some implementations, the MCU board 110 includes one or more processors. For example, the MCU board 110 can also include one or more field-programmable gate arrays. The MCU 106 can also include one or more other components for controlling the motor 102. For example, gate drivers, shunt monitors, and cooling features can be included.

The inverter 108 can include one or more power stages to convert direct current (DC) to alternating current (AC) to drive the motor 102, and to convert AC to DC when recovering energy from the motor 102. The inverter 108 can use transistors 112 that are toggled on and off repeatedly to generate AC for, or recover energy from, the motor 102. In some implementations, six of the transistors 112 can be coupled in respective pairs to produce three-phase AC. The transistors 112 can be metal-oxide semiconductor field-effect transistors (MOSFETs). For example, silicon carbide MOSFETs can be used. In some implementations, insulated-gate bipolar transistors (IGBTs) can be used.

The vehicle 100 includes a battery 114. The battery 114 can include one or more modules of electrochemical cells. For example, lithium-ion cells can be used. The battery 114 can be controlled by a battery management unit (BMU) 116. For example, the BMU 116 can manage a state of charge of the battery 114, and open and close the contactors between the battery 114 and the inverter 108. The battery 114, which is the energy source for vehicle propulsion, can be referred to as a high-voltage battery to distinguish it from a low-voltage (e.g., 12 V) battery that can power one or more components (e.g., the MCU board 110).

The vehicle 100 includes a vehicle control unit (VCU) 118. The VCU 118 can control the operational state of the vehicle 100. In some implementations, the VCU 118 can be coupled to both the BMU 116 and the MCU board 110. For example, the VCU 118 can coordinate torque requests regarding the motor 102, such as based on a driver depressing an accelerator pedal. In response to a torque request from the VCU 118, the MCU 106 can apply voltage to stator windings of the motor 102 to generate current in the stator windings that, in turn, generates a magnetic field that rotates, and produces torque with, the motor 102's rotor.

The vehicle 100 includes a sensor 120 that can indicate a rotational position of the rotor in the motor 102. In some implementations, the sensor 120 can be mounted to a shaft of the rotor and can give angle measurements. Using these angle measurements, the MCU 106 can determine rotational speed of the motor 102. For example, in some implementations, the sensor 120 can include analog circuitry (e.g., a resolver) or digital circuitry (e.g., an encoder). In the approaches described herein, a rotational sensor, such as the sensor 120, can also be referred to as a resolver.

Using the approaches described herein, the MCU 106 of the vehicle 100 can perform a calibration process (e.g., using hardware, software, and/or firmware included in the MCU 106 and/or in other components of the vehicle 100) to determine an angular position sensing angle offset of the sensor 120. This determined angle offset can then be used by the MCU 106 (e.g., as an adjustment to angular position information received from the sensor 120) to accurately determine angular positions of the motor 102's for torque generation, etc. For instance, such adjusted angular position information can be used by the MCU 106 to decide when to apply current the motor 102's stator to generate torque in response to a torque command from the VCU 118.

FIG. 2 schematically shows a cross-sectional view of an example permanent magnet synchronous motor (PMSM) 200 that can be included in the vehicle 100 in FIG. 1. For instance, the PMSM 200 can implement the motor 102, and the sensor 120 can be used for sensing an angular position of a rotor 202 of the PMSM 200. Accordingly, for purposes of illustration, the PMSM 200 of FIG. 2 will be described with further reference to FIG. 1. Though the sensor 120 is not specifically shown in FIG. 2, a sensing angle offset Θ of the sensor (resolver) 120, in this example, is shown in FIG. 2.

The rotor 202 of the PMSM 200 is enclosed within a stator 204 and, as shown in this view, the rotor 202 is angularly positioned such that a magnetic axis of the rotor 202 is aligned with a zero-degree reference of the motor 200, or the stator 204, where the stator 204 remains in a fixed position relative to rotation of the rotor 202 during operation of the PMSM 200. The PMSM 200 includes magnetic poles 206a (e.g., a north pole) and 206b (e.g., a south pole) within the rotor 202, where the magnetic poles 206a and 206b define the magnetic axis of the rotor 202, which can also be referred to as a direct-axis (d-axis) 208a. As noted above, in the view shown in FIG. 2, the d-axis 208a (e.g., magnetic axis of the rotor 202) is arranged such that it is aligned with the zero-degree reference of the PMSM 200.

As also shown in FIG. 2, an axis that is at a 90-degree angle with the d-axis 208a, which can be referred to as quadrature-axis (q-axis) 210a, is also shown. The d-axis 208a and the q-axis 210a can be collectively referred to as dq-axes, or a dq-axis coordinate system. This dq-axis coordinate system provides a rotor reference frame for the PMSM 200 and, when modeling or describing operation of the PMSM 200, the dq-axis coordinate system is considered to rotate with the rotor 202 (e.g., in a direction 205), e.g., at a same speed as the rotor 202 and in the same relative alignment shown in FIG. 2.

Also shown in FIG. 2 are a d-axis (sensor) 208b and a q-axis (sensor) 210b, which are axes that illustrate the sensing angle offset Θ of the sensor 120, e.g., dq-axis coordinate system without calibration for the angle offset Θ. That is, without performing sensor angle offset calibration for the angle offset Θ of the sensor 120, and using only angular position information provided by the sensor 120, the determined position of the rotor 202 (when the d-axis 208a is physically aligned with the zero-degree reference of the PMSM 200 as shown in FIG. 2) will be at the sensor angle offset Θ, rather than at the true zero-degree reference. Because, as noted above, such angular position sensing angle offsets are generally mechanical offsets, e.g., due to mechanical and/or manufacturing tolerances, the angle offset Θ will be substantially independent of an angular position of the rotor 202, as well as substantially independent of electrical operating characteristics and environmental conditions (e.g., temperature, etc.) of the PMSM 202.

In an example implementation, operation of the PMSM 200 can be modeled using the following equations, respectively Equations 1 and 2:

$${V}_{q}^{r} = {R}_{s} {i}_{q}^{r} + {L}_{q} \frac{d {i}_{q}^{r}}{d t} + {ω}_{e} {L}_{d} {i}_{d}^{r} + {ω}_{e} {λ}_{p m} \qquad ( Equation 1 )$$

$${V}_{d}^{r} = {R}_{s} {i}_{d}^{r} + {L}_{d} \frac{d {i}_{d}^{r}}{d t} - {ω}_{e} {L}_{q} {i}_{q}^{r} , \qquad ( Equation 2 )$$

where v_{q}^{r} is q-axis voltage (V_{q}) in the rotor reference frame; v_{d}^{r} is d-axis voltage (V_{d}) in the rotor reference frame; i_{q}^{r} is q-axis current in rotor reference frame; i_{d}^{r} is d-axis current in rotor reference frame; Rₛ is stator resistance; L_{q} is q-axis inductance; L_{d} is d-axis inductance; λₚₘ is permanent magnet flux linkage; and ωₑ is electric rotor speed.

Using the above modeling equations, if angular position sensing is accurate (e.g., a position sensing angle offset is about zero), at a non-zero rotor speed, and with zero dq-axis current (no torque applied by the motor with the motor freely spinning), Equation 1 reduces to v_{q}^{r}=ωₑλₚₘ, and Equation 2 reduces to v_{d}^{r}=0. Accordingly, with no current applied to the stator, and the rotor 202 rotating at a non-zero speed, if angular sensing is accurate, q-axis voltage (v_{q}) in the rotor reference frame is given by a product of the rotational speed we and the permanent magnet flux linkage λₚₘ, and the d-axis voltage (V_{d}) in the rotor reference frame is zero. Stated another way, when angular position sensing is accurate, the measured voltage generated in the stator 204 as a result of the rotor 202 freely rotating without applied torque, which is referred to as back electromotive force (backEMF), will substantially be entirely in the q-axis (V_{q}) in the rotor reference frame of the dq-axis coordinate system.

However, if angular position sensing is not accurate, e.g., is offset by Θ as in this example, the dq-axis coordinate system defined based on the measured angular position of the rotor 202 (e.g., the d-axis (sensor) 208b and the q-axis (sensor) 210b axes) will deviate from the actual rotor position with respect to the stator 204. In this case, backEMF of the PMSM 200 will exist on both the d-axis 208a (V_{q}) and (V_{q}) in the measured rotor frame of reference. As noted above, such an angle offset can adversely impact torque generation and overall EV efficiency.

Using the approaches described herein, calibration for a position sensing angle offset of a rotational position sensor (e.g., the angle offset Θ of the sensor 120) can be achieved by determining the angle offset Θ by rotating the rotor 202 of the PMSM 200 at a non-zero speed and forcing applied current in the stator 204 to zero, which can be referred to as applying a zero-volt V_{d} a command or zero V_{d} command. The applied zero V_{d} command can then be compared with a measured V_{d}, and a regulator controller can be used to determine the angle offset Θ based on when the measured V_{d} in the rotor reference frame matches the applied zero V_{d} command (e.g., when a measured V_{d} is about zero in the rotor reference frame). Accordingly, the calibration approaches described herein can be referred to as direct-axis voltage based (V_{d}-based) angle offset calibration. The determined offset can then be used, in combination with the measured angular position (e.g., adding the angle offset Θ to measured position), to achieve accurate position measurements for the rotor 202. In example implementations, the angle offset Θ can be either a positive angle or a negative angle (e.g., relative to the d-axis 208a and the q-axis 210a).

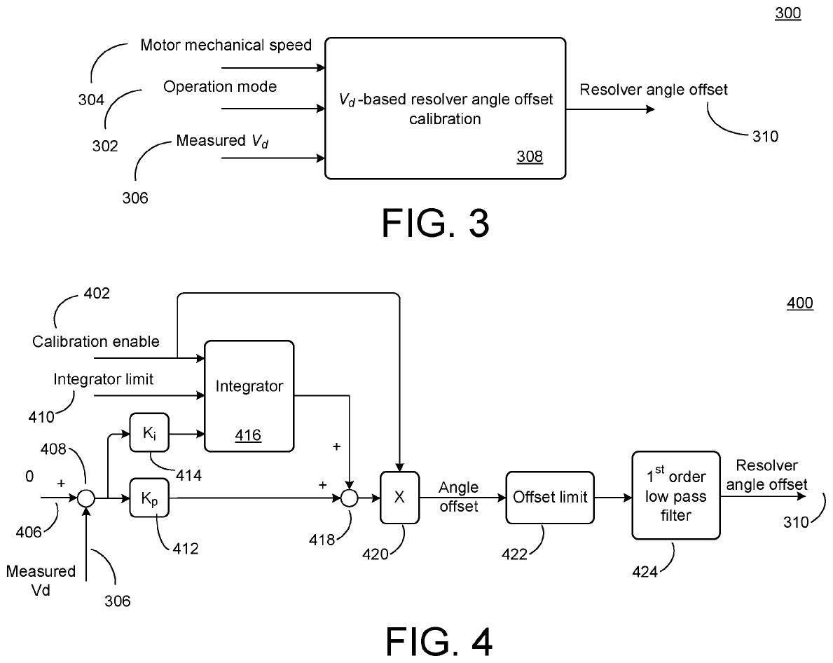

FIG. 3 schematically shows an example process 300 for angular position sensor angle offset calibration. In an example implementation, the process 300 can be performed by the MCU 106 of FIG. 1. For instance, the MCU 106 can perform the process 300 for a resolver (e.g., the sensor 120) of the PMSM 200 using hardware, software, and/or firmware included in the MCU 106, and/or in conjunction with other components of the vehicle 100. Accordingly, for purposes of illustration, the process of FIG. 3 will be described with further reference to FIGS. 1 and 2.

As shown in FIG. 3, the process 300 includes providing an operation mode signal 302, a motor mechanical speed 304 and a measured direct-axis voltage (V_{d}). At operation 308, V_{d}-based resolver angle offset calibration can be performed to determine an angle offset that corresponds with a measured direct-axis voltage V_{d} 306 in the rotor frame of reference substantially matching a reference of zero (e.g., indicating approximately zero backEMF in the d-axis 208a, and a desired zero direct-axis voltage). In example implementations, determining the angle offset can be achieved by convergence of a proportional integral controller with the measured V_{d} 306 as feedback compared with the zero reference. In this example, the operation mode signal 302 can be a signal that indicates angle offset calibration is to be performed. The operation mode signal 302, in combination with the motor mechanical speed 304 being greater than a threshold speed, can enable angle offset calibration in the process 300.

In example implementations, the mechanical motor speed threshold can be about 200 revolutions per minute (e.g., a minimum threshold), which can improve a signal to noise ratio for backEMF measurements as compared to lower speeds. As shown in FIG. 3, the result of the calibration 308 is a resolver angle offset 310 (e.g., the angle offset Θ for the PMSM 200). The MCU 106 can then use the resolver angle offset 310 in combination with angle measurement information provided by the sensor (resolver) 120 to accurately determine angular position of the rotor 202 when controlling the PMSM 200 (e.g., applying torque). For instance, the resolver angle offset 310 can be added to an angle of a measured position of the rotor 202.

FIG. 4 shows an example process 400, which is a more detailed implementation of the process 300 of FIG. 3. In this example, the process 400 can be enabled based on a calibration enable signal 402, which can be set to TRUE in response to an operation mode signal (signal 302) indicating angle offset calibration should be performed and a motor mechanical speed (motor mechanical speed 304) being above a threshold, such as described above. The process 400 of FIG. 4 is implemented as a regulator controller that includes a proportional integral controller to achieve angle offset calibration. The process 400, when enabled, uses a measured V_{d} in the rotor frame of reference as compared to a reference (desired) direct-axis voltage (reference V_{d}) 406 of zero to determine a resolver angle offset. For purposes of illustration, the measured V_{d} and the resolver angle offset are referenced in FIG. 4 with the same reference numbers as in FIG. 3, respectively 306 and 310. In example implementations, the process 400 can be iteratively repeated to adjust an estimated resolver angle offset, until the determined resolver angle offset converges on an angle offset value (e.g., final angle offset value), where the measured V_{d} 306 substantially matches, or is substantially equal to the reference V_{d} command 306 of zero, indicating that the determined resolver angle offset 310 is substantially equal to the angle offset of a corresponding angular position sensor or resolver.

As can be seen in FIG. 4, the process 400 includes receiving, at a difference generation operation 408, the reference V_{d} 406 of zero and, as feedback, the measured direct-axis voltage V_{d} 306. The difference generation operation 408 determines a difference between the reference V_{d} 406 and the measured V_{d} 306, which is then provided to a proportional integral (PI) controller. On a first path of the PI controller, a proportional gain Kₚ is applied to the difference from the operation 412. Further, on a second path of the PI controller, at operation 414, an integral gain Kᵢ is applied to the difference from the operation 408. The proportional gain Kₚ and the integral gain Kᵢ can, for a given implementation, be experimentally determined to achieve desired convergence speed and angle offset determination accuracy of the process 400.

At operation 416, integration, when enabled by the calibration enable signal 402, is performed on the value produced at operation 414. The integration 416 can be performed in accordance with an integration limit 410 that prevents integration trending toward infinity.

In the process 400, the respective outputs of the proportional gain operation 412 and the integration operation 416 are both provided to a summation operation 418. The summation operation 418 generates a sum of the outputs of the operations 412 and 416, and provides that result to a multiply operation 420. The operation 420 multiplies the result from the operation 418 by a value corresponding with the calibration enable signal 402. In an example implementation, if the calibration signal 402 is set to TRUE or logic 1, the multiply operation 420 passes the result of the operation 420 as an angle offset value (e.g., uses a multiplication value of one), while if the calibration signal 402 is set to FALSE or logic 0, the multiply operation 420 zeros the result of the operation 418, e.g., due to angle offset calibration being disabled.

The angle offset from the operation 420 can then be provided to an offset limit operation 422, which compares the provided angle offset from the operation 420 with an expected range of angle offset values for a given implementation. If the provided angle offset from the operation 420 is above an upper offset limit, the operation 422 can provide the upper offset limit as its output, while if the provided angle offset is below a lower offset limit, the operation 422 can provide the lower offset limit as its output. Otherwise, the operation 422 can provide, as its output, the angle offset from the operation 420. In this example, the lower and upper offset limits can be based on expected mechanical variation in alignment of a rotational position sensor and a corresponding PMSM rotor, which can help achieve convergence of the process 400.

As shown in FIG. 4, the output of the operation 422 can be provided to a first order low pass filter 424, which can remove high-frequency noise from a signal indicating a determined angle offset. The filter 424 can then provide the filtered signal as the resolver angle offset 310. In example implementations, the process 400 can be iteratively repeated until convergence is achieved, e.g., where the measured V_{d} 306 substantially equals the reference V_{d} 406 of zero. Once convergence is achieved, the resultant value of the resolver angle offset 310 can be stored (e.g., in non-volatile memory of an associated MCU) and used to control a corresponding PMSM by combining (adding) the resolver angle offset 310 to a measured angular position of a rotor of the PMSM, e.g., for use in torque generation, rotor angular position determination, etc.

The terms “substantially” and “about” used throughout this Specification are used to describe and account for small fluctuations, such as due to variations in processing. For example, they can refer to less than or equal to ±5%, such as less than or equal to ±2%, such as less than or equal to #1%, such as less than or equal to ±0.5%, such as less than or equal to ±0.2%, such as less than or equal to ±0.1%, such as less than or equal to ±0.05%. Also, when used herein, an indefinite article such as “a” or “an” means “at least one.”

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein.

A number of implementations have been described. Nevertheless, it will be understood that various modifications may be made without departing from the spirit and scope of the specification.

In addition, the logic flows depicted in the figures do not require the particular order shown, or sequential order, to achieve desirable results. In addition, other processes may be provided, or processes may be eliminated, from the described flows, and other components may be added to, or removed from, the described systems. Accordingly, other implementations are within the scope of the following claims.

While certain features of the described implementations have been illustrated as described herein, many modifications, substitutions, changes and equivalents will now occur to those skilled in the art. It is, therefore, to be understood that appended claims are intended to cover all such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components and/or features of the different implementations described.

1. A method comprising:
measuring, for a permanent magnet motor having a rotor rotating at a speed, a direct-axis voltage in a rotor frame of reference, the speed being determined by an angular position sensor;
comparing the measured direct-axis voltage with a reference voltage;
determining, based on the comparing, an angle offset estimate of the angular position sensor; and
iteratively adjusting the angle offset estimate until the measured direct-axis voltage substantially equals the reference voltage.

2. The method of claim 1, wherein comparing the measured direct-axis voltage with the reference voltage includes comparing the measured direct-axis voltage with the reference voltage with a proportional integral controller.

3. The method of claim 2, wherein the reference voltage is zero volts.

4. The method of claim 2, wherein the proportional integral controller is configured to implement a regulator controller.

5. The method of claim 2, wherein the proportional integral controller is enabled in response to:
an enable signal; and
the speed being greater than or equal to a threshold speed.

6. The method of claim 1, wherein the reference voltage is zero volts.

7. The method of claim 1, further comprising generating torque with the permanent magnet motor based, at least in part, on the iteratively determined angle offset.

8. The method of claim 1, wherein measuring the direct-axis voltage includes measuring the direct-axis voltage with the rotor freely spinning at the speed.

9. A vehicle comprising:
a permanent magnet motor including:
a stator;
a rotor; and
an angular position sensor; and
a motor controller configured to:
measure, with the rotor rotating at a speed, a direct-axis voltage in a rotor frame of reference, the speed being determined by the angular position sensor;
compare the measured direct-axis voltage with a reference voltage;
determine, based on the comparing, an angle offset estimate of the angular position sensor; and
iteratively adjusting the angle offset estimate until the measured direct-axis voltage substantially equals the reference voltage.

10. The vehicle of claim 9, wherein the direct-axis voltage is measured in the stator.

11. The vehicle of claim 9, wherein comparing the measured direct-axis voltage with the reference voltage includes comparing the measured direct-axis voltage with a reference voltage with a proportional integral controller.

12. The vehicle of claim 11, wherein the reference voltage is zero volts.

13. The vehicle of claim 11, wherein the proportional integral controller includes a regulator controller.

14. The vehicle of claim 11, wherein the proportional integral controller is configured to be enabled in response to:
an enable signal; and
the speed being greater than or equal to a threshold speed.

15. The vehicle of claim 9, wherein the reference voltage is zero.

16. The vehicle of claim 9, wherein the permanent magnet motor is configured to generate torque based, at least in part, on the iteratively determined angle offset.

17. The vehicle of claim 9, wherein measuring the direct-axis voltage includes measuring the direct-axis voltage with the rotor freely spinning at the speed.
